(19) United States
(12) Patent Application Publication
(10) Pub. No.: US 2022/0318496 A1
(43) Pub. Date: Oct. 6, 2022

(54) MULTISTAGE INFERENCE APPARATUS AND MULTISTAGE INFERENCE METHOD

(71) Applicant: Hitachi, Ltd., Tokyo (JP)

(72) Inventors: Hiroko OTAKI, Tokyo (JP); Kunihiko KIDO, Tokyo (JP)

(73) Assignee: Hitachi, Ltd., Tokyo (JP)

(21) Appl. No.: 17/686,057

(22) Filed: Mar. 3, 2022

(30) Foreign Application Priority Data
Mar. 31, 2021 (JP) 2021-059958

(51) Int. Cl. G06F 40/20; G06F 40/194

(52) U.S. Cl. CPC G06F 40/20; G06F 40/194

(57) ABSTRACT

A multistage inference system includes a causality expression storage unit that stores a plurality of sentences including a pair of a phrase representing a cause and a phrase representing an effect, and a scenario reliability calculator that calculates a score for evaluating causality chain possibility among the sentences. The score is calculated based on type identity of documents including the sentences or information on authors of the documents.

### BACKGROUND OF THE INVENTION

### 1. Field of the Invention

The present invention relates to a technique for analyzing causality between constitutive elements of an incident, and relates to a technique for generating a causality candidate (hereinafter, referred to as a scenario candidate) obtained by chaining expressions representing causalities.

### 2. Description of the Related Art

The causality refers to data that is an ordered pair of event expressions representing a cause and an effect thereof, such as “uric acid accumulates->uric acid crystallizes”, “uric acid crystallizes->white blood cells attack”, and “white blood cells attack->inflammation occurs”. An expression including three or more event expressions such as “uric acid accumulates->uric acid crystallizes->white blood cells attack->inflammation occurs” obtained by chaining two or more such causalities is referred to as a scenario.

Hashimoto et al., 2014, “Toward Future Scenario Generation: Extracting Event Causality Exploiting Semantic Relation, Context, and Association Features.” In Proceedings of the 52nd Annual Meeting of the Association for Computational Linguistics (ACL 2014), pp. 987-997, has reported that a scenario “global warming worsens->sea temperatures rise->vibrio parahaemolyticus fouls (water)->food poisoning increases”, which is described in a paper published in 2013, had been generated by using only documents before the paper was submitted. The technique described in Hashimoto et al., 2014 generates a scenario by linking causalities acquired from a large-scale web archive. The causalities acquired by the authors each consist of two events such as “global warming worsens->sea temperatures rise”. Then, linking two causalities “global warming worsens->sea temperatures rise” and “sea temperatures rise->vibrio parahaemolyticus fouls (water)” results in generation of the scenario “global warming worsens->sea temperatures rise->vibrio parahaemolyticus fouls (water)”.

In Hashimoto et al., 2014, it is determined that two causalities can be linked when an effect part of one of the two causalities and a cause part of the other are determined to be substantially the same, so that a generated scenario might be incoherent in context and incorrect.

On the other hand, JP 2018-55142 A discloses a method of calculating reliability of a scenario candidate for determining whether the scenario candidate is coherent in context and plausible. In JP 2018-55142 A, a text passage is found out in which noun phrases included in a causality, which represent events such as global warming and sea temperatures in the example of “global warming worsens->sea temperatures rise”, are described within a certain range of a document. Then, a reliability of a scenario candidate is calculated from a score indicating how much the scenario candidate is supported by the text passage of the actual document, a causality score for judging whether polarities of linked causalities are the same, and a similarity of original documents from which causalities are extracted.

### SUMMARY OF THE INVENTION

A scenario candidate ranking intrinsically changes depending on how a scenario obtained by linking causalities is used. The method of JP 2018-55142 A is applicable to work of seeking a scenario that has a high similarity in context and is often described in documents, but is not assumed to be used for finding out a scenario that has a high similarity in context and is less known. For example, in work of developing a new drug, there is a problem that an entire scenario is required to be consistent while attention is paid to an unknown relation instead of a known relation.

In order to solve the above problem, the present invention provides a multistage inference system including a feature generating unit configured to receive a scenario candidate including at least three event expressions, the scenario candidate being likely to represent chained causalities, and extract a feature from the scenario candidate and original documents from which causalities as constitutive elements of the scenario candidate are extracted, and a score selecting means that selects and outputs a maximum value among scores indicating reliability of the scenario candidate as a reliability of the scenario candidate for each of scenario candidates.

Furthermore, in order to achieve the above object, the present invention provides a multistage inference method comprising receiving a scenario candidate including at least three event expressions, the scenario candidate being likely to represent chained causalities, extracting a feature from the scenario candidate and original documents from which causalities as constitutive elements of the scenario candidate are extracted, outputting scores indicating reliability of the input scenario candidate, the scores being calculated based on the feature for each of scenario candidates, and selecting and outputting a maximum value among the output scores as a reliability of the scenario candidate for each of the scenario candidates.

According to the present invention, a scenario candidate closer to a user's attention point is displayed at a higher rank, thereby reducing the time the user takes to search entire scenario candidates.

### BRIEF DESCRIPTION OF THE DRAWINGS

FIG. 1 is a block diagram illustrating a configuration of a multistage inference system according to a first embodiment;

FIG. 2 is a block diagram illustrating a configuration of a feature generating unit used in the multistage inference system according to the first embodiment; and

FIG. 3 is a view of an example of a scenario candidate selection screen used in the multistage inference system according to the first embodiment.

### DESCRIPTION OF THE PREFERRED EMBODIMENT

A preferred embodiment of the present invention will be described in detail below with reference to the accompanying drawings.

### First Embodiment

A first embodiment is an embodiment of a multistage inference system including a feature generating unit configured to receive a scenario candidate including at least three event expressions, the scenario candidate being likely to represent chained causalities, and extract a feature from the scenario candidate and original documents from which causalities as constitutive elements of the scenario candidate are extracted, and a score selecting means that selects and outputs a maximum value among scores indicating reliability of the scenario candidate as a reliability of the scenario candidate for each of scenario candidates. The first embodiment is also an embodiment of a method of the multistage inference system.

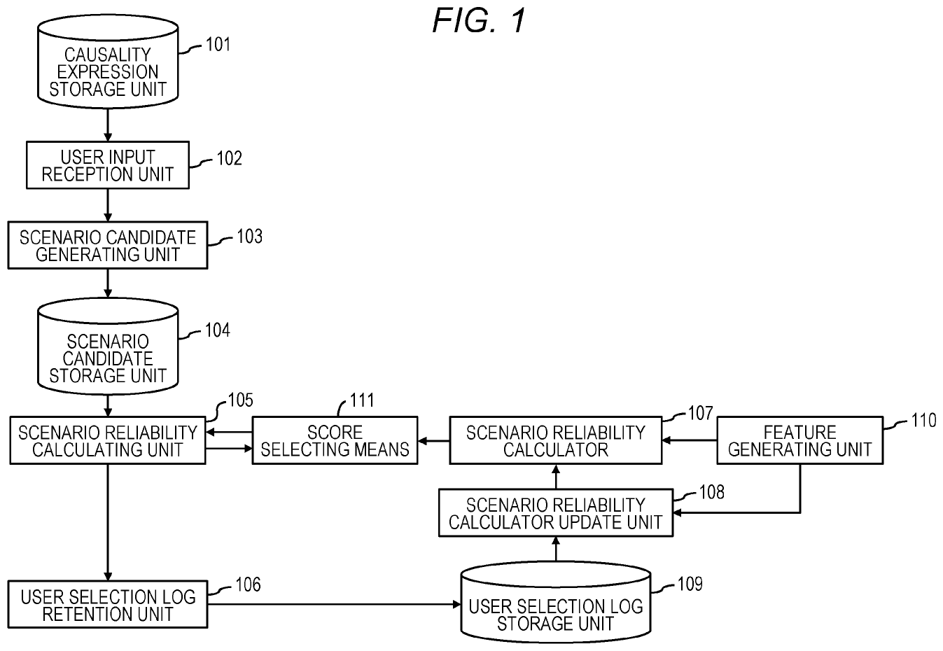

FIG. 1 illustrates a configuration of the multistage inference system according to the first embodiment. The multistage inference system according to the first embodiment includes a causality expression storage unit 101, a user input reception unit 102, a scenario candidate generating unit 103, a scenario candidate storage unit 104, a scenario reliability calculating unit 105, a user selection log retention unit 106, a scenario reliability calculator 107, a scenario reliability calculator update unit 108, a user selection log storage unit 109, a feature generating unit 110, and a score selecting means 111. Note that the generation and calculation functional blocks such as the scenario candidate generating unit 103, the scenario reliability calculating unit 105, and the feature generating unit 110 can be implemented by program processing in a central processing unit (CPU) that is a processing unit of a normal computer.

The causality expression storage unit 101 is a computer-readable storage device for storing a large number of causality expressions each consisting of a pair of event expressions representing a causality. The user input reception unit 102 specifies an event expression as a start point and an event expression as an end point depending on user's interest, a user's attention point such as a viewpoint that a scenario candidate has a high rarity value or a scenario candidate is stable, and the number of event expressions to be chained.

The scenario candidate generating unit 103 retrieves, out of causalities to be examined included in the causality expression storage unit 101, a pair of causalities such that an effect part of one of the causalities and a cause part of the other substantially match each other, and generates a scenario candidate by chaining this pair at the substantially matching part. The scenario candidate storage unit 104 stores a large number of scenario candidates generated by the scenario candidate generating unit 103. For each of the scenario candidates stored in the scenario candidate storage unit 104, the scenario reliability calculating unit 105 calculates, in light of context and appearance frequencies of event expressions, scores indicating whether the scenario candidate is appropriate for representing a causality relevant to the viewpoint of the user's interest received from the user, and outputs a scenario candidate ranking in which the scenario candidates are arranged in score-descending order.

The scenario candidate generating unit 103 includes a causality pair selecting unit that selects, out of the causalities stored in the causality expression storage unit 101, a pair of causalities such that the start point specified by the user input is included as a cause part and an effect part of one of the causalities and a cause part of the other share a noun phrase, and a causality candidate selecting unit that selects, out of pairs of causalities selected by the causality pair selecting unit, a causality candidate having the noun phrase shared by both as the effect part. The causality candidate selecting unit repeatedly chains event expressions to create a scenario candidate such that this chain of causalities complies with the number of event expressions to be chained specified by the user input. When the user input specifies the end point, scenario candidates are restricted to that having the specified end point event as an effect part. The user input may specify not only the start point and the end point but also a middle point.

The scenario reliability calculating unit 105 sequentially retrieves the scenario candidates stored in the scenario candidate storage unit 104 one by one, extracts features as described later for each retrieved scenario candidate, selects the scenario reliability calculator 107 in accordance with the user's attention point specified by the user such as a viewpoint that a scenario candidate has a high rarity value or a scenario candidate is stable, causes the selected scenario reliability calculator 107 to calculate a reliability of the scenario, and arranges the scenario candidates in order of the reliability for display on a scenario candidate selection screen. The calculation of the reliability of a scenario candidate performed by the scenario reliability calculating unit 105 may be similar to that in Hashimoto et al., 2014.

The user selection log retention unit 106 records, in a user selection log, a selection log of the user on the scenario candidate selection screen together with the user's attention point such as a viewpoint that a scenario candidate has a high rarity value or a scenario candidate is stable. When the user selection log is accumulated, the scenario reliability calculator update unit 108 updates the scenario reliability calculator 107 depending on the user's attention point.

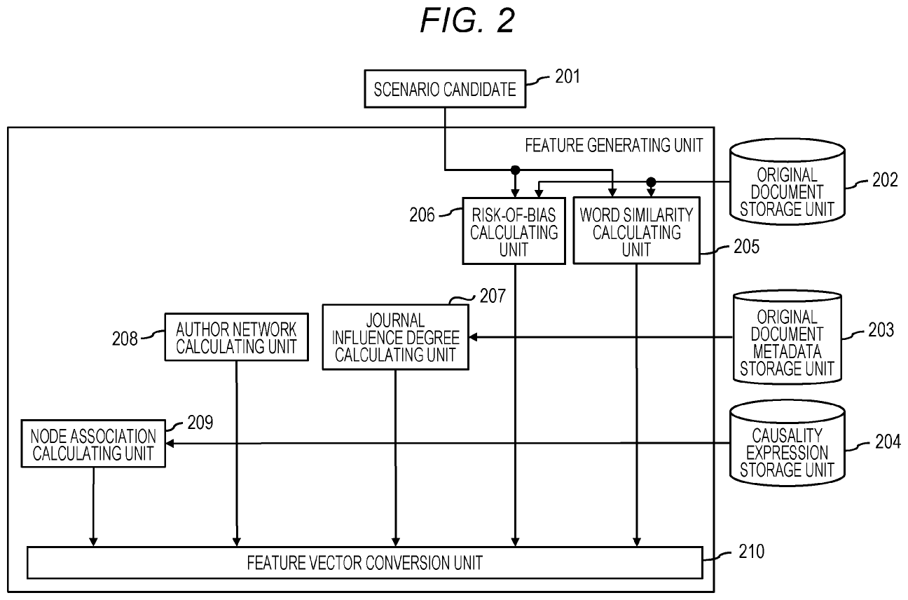

FIG. 2 illustrates a configuration example of the feature generating unit 110 used in the multistage inference system according to the first embodiment. The features generated by the feature generating unit 110 include a word similarity that is an index of a similarity between original documents from which causalities included in a scenario candidate are extracted, a risk of bias that is an index for judging, when an original document from which a causality included in the scenario candidate is extracted is a paper in a medical field, whether a reported study incorporates a high-quality experimental system, a journal influence degree for judging, when an original document from which a causality included in the scenario candidate is extracted is a paper, whether the original document has been published in a journal with high influence and a high impact factor, an author network indicating whether an original document belongs to an author group conducting studies on similar problems, and the number of chained causalities such that an effect part of one of the causalities and a cause part of the other substantially match each other.

These features are calculated by a word similarity calculating unit 205, a risk-of-bias calculating unit 206, a journal influence degree calculating unit 207, an author network calculating unit 208, and a node association calculating unit 209, and are converted into a feature vector by a feature vector conversion unit 210.

The word similarity calculating unit 205 calculates a cosine similarity of word overlapping between original documents from which causalities included in the scenario candidate are extracted. A context similarity of the original documents from which the causalities included in the scenario candidate are extracted is measured. In a case where three or more causalities are chained in the scenario candidate, a similarity between original documents from which two adjacent causalities are extracted is calculated, such as between an original document from which a first causality is extracted and an original document from which a second causality is extracted, and between the original document from which the second causality is extracted and an original document from which a third causality is extracted. All the similarities are added up. In addition to the similarities between the original documents from which the two adjacent causalities are extracted, a similarity between an original document from which the first causality is extracted and an original document from which the last causality is extracted may be included.

The risk-of-bias calculating unit 206 calculates a risk of bias that is an index for judging, when an original document from which a causality included in the scenario candidate is extracted is a paper in a medical field, whether a reported study incorporates a high-quality experimental system. That is, in a case of a document in which comparison is performed with respect to intervention of a drug, a therapy, or the like, the risk-of-bias calculating unit 206 calculates a numerical value of the risk of bias by scoring whether there are a non-treatment control group and a treatment group for an experiment to be performed, whether subjects are allocated at random to the two groups such that deviations in age, sex, and disease background are as identical as possible, whether an experimental system is incorporated in which, when there is a placebo or control group, neither doctors nor subjects know if they are in a drug or therapy group or the control group.

The journal influence degree calculating unit 207 calculates a journal influence degree for judging, when an original document from which a causality included in the scenario candidate is extracted is a paper, whether the original document has been published in a journal with high influence and a high impact factor.

The author network calculating unit 208 creates a network connecting authors by a referenced relationship in a reference. The author network is clustered. Then, an author group identity between original documents from which two adjacent causalities are extracted is calculated for each cluster, such as between the original document from which the first causality is extracted and the original document from which the second causality is extracted, and between the original document from which the second causality is extracted and the original document from which the third causality is extracted. All the identities are added up. In addition to the identities between the original documents from which the two adjacent causalities are extracted, an author group identity between the original document from which the first causality is extracted and the original document from which the last causality is extracted may be included.

The node association calculating unit 209 chains, in generating a scenario, causalities such that an effect part of one of the causalities and a cause part of the other substantially match each other. In chaining the causalities at the effect part of one of the causalities and the cause part of the other, the number of possible causalities to be chained can be calculated when viewed from the cause part. In a case of an event that frequently appears as a cause part, there are many possible causalities to be chained, whereas in a case of an event that rarely appears, there are a few possible causalities to be chained.

In developing a new drug, a well-known causality in a living body is often already used for the drug development, leading to a need for a less known causality to be used to constitute a scenario. However, the user has a need for a scenario including a less known causality and having consistency in the entire context, for example, a more consistent scenario combining causalities of reactions in a brain rather than a causality combining a reaction in a brain and a reaction in a foot. Thus, the features include both the context similarity and the number of chained events. When causalities to be chained are described in the same document, the context similarity is highest but the causalities described in the same document are likely to have a relatively well-known relation. When the causalities are not in the same document but the context similarity is high, they are likely to have a less known relation. It is considered that the context similarity and the number of chained causalities are in a trade-off relationship, and the scenario reliability calculator 107 works to conform them to the user's attention point.

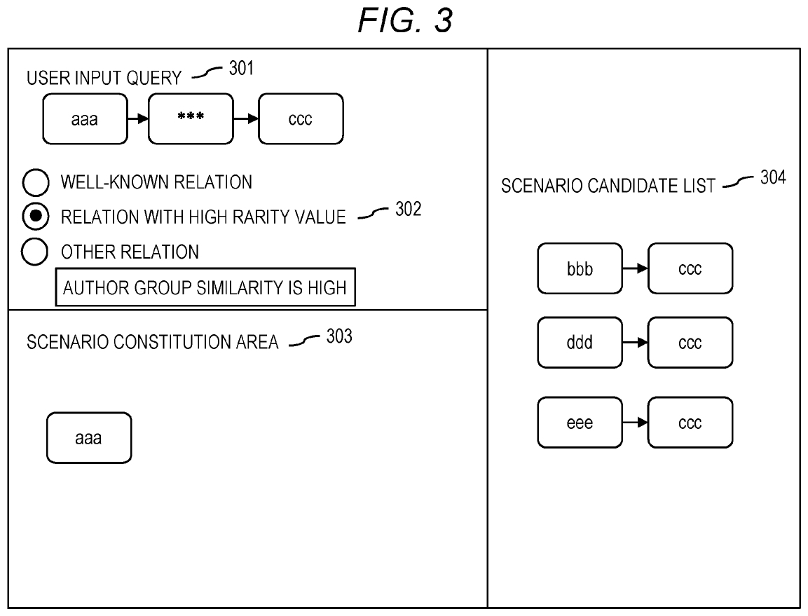

FIG. 3 illustrates an example of the scenario candidate selection screen used in the multistage inference system according to the first embodiment. As illustrated in the figure, the user specifies a keyword as the start point and a keyword as the end point for generating a scenario, how many causalities constitute the scenario to be generated, and the like from a user input query 301. Then, the user's attention point in the scenario is simultaneously input from a user attention point input unit 302. For example, the user's attention point can be selected from well-known relation, relation with high rarity value, other relation, and the like. This selection results in using the scenario reliability calculator 107 in accordance with the attention point. When other relation is specified in the user attention point input unit 302, the scenario reliability calculating unit 105 is unable to create a ranking in accordance with the input, but the input is used when the scenario reliability calculator update unit 108 uses the log to update the scenario reliability calculator 107.

A scenario candidate list 304 arranges and displays scenarios sorted in accordance with the query specified by the user. The user selects a scenario matching user's intention from the scenario candidate list 304 by drag-and-drop, and decides a scenario in a scenario constitution area 303. The decided scenario and the ranking are left as the log.

According to the multistage inference apparatus and the method thereof according to the first embodiment described in detail above, it is possible to connect a start point and an end point by causalities stored in the causality expression storage unit using, as input, an event as the start point and an event as the end point of a scenario that the user desires to search as well as a user's attention point, and to rearrange, from the user's attention point, scenario candidates generated by chaining the causalities.

The present invention is not limited to the above-described embodiment, and may include various modifications. For example, the above-described embodiment has been described in detail for better understanding of the present invention, and all the configurations of the description are not necessarily included. Furthermore, the above-described configurations, functions, various calculating units, generating units, and the like can be implemented by creating a program for realizing a part or all of them, which of course may be realized by hardware, for example, by designing with an integrated circuit. That is, a part or all of the functions of the calculating units and the generating units may be implemented by, for example, an integrated circuit such as an application specific integrated circuit (ASIC) or a field programmable gate array (FPGA) instead of the program.

What is claimed is:

1. A multistage inference system comprising:
a feature generating unit configured to receive a scenario candidate including at least three event expressions, the scenario candidate being likely to represent chained causalities, and extract a feature from the scenario candidate and original documents from which causalities as constitutive elements of the scenario candidate are extracted; and
a score selecting means that selects and outputs a maximum value among scores indicating reliability of the scenario candidate as a reliability of the scenario candidate for each of scenario candidates.

2. The multistage inference system according to claim 1, comprising
a score output means that has learned in advance by machine learning to output scores indicating the reliability of the scenario candidate, the scores being calculated based on the feature received by the score output means for each of the scenario candidates.

3. The multistage inference system according to claim 2, wherein
the feature generating unit includes a word similarity calculating unit that calculates a cosine similarity of word overlapping between original documents from which causalities included in the scenario candidate are extracted.

4. The multistage inference system according to claim 2, wherein
the feature generating unit includes a risk-of-bias calculating unit that calculates a risk of bias that is an index for judging, when an original document from which a causality included in the scenario candidate is extracted is a paper in a medical field, whether a reported study incorporates a high-quality experimental system.

5. The multistage inference system according to claim 2, wherein
the feature generating unit includes a journal influence degree calculating unit that calculates a journal influence degree for judging, when an original document from which a causality included in the scenario candidate is extracted is a paper, whether the original document has been published in a journal with high influence and a high impact factor.

6. The multistage inference system according to claim 2, wherein
the feature generating unit includes an author network calculating unit that creates a network connecting authors by a reference relationship in a reference.

7. A multistage inference method comprising:
receiving a scenario candidate including at least three event expressions, the scenario candidate being likely to represent chained causalities;
extracting a feature from the scenario candidate and original documents from which causalities as constitutive elements of the scenario candidate are extracted;
outputting scores indicating reliability of the input scenario candidate, the scores being calculated based on the feature for each of scenario candidates; and
selecting and outputting a maximum value among the output scores as a reliability of the scenario candidate for each of the scenario candidates.

8. The multistage inference method according to claim 7, comprising
calculating a cosine similarity of word overlapping between original documents from which causalities included in the scenario candidate are extracted to extract the feature from the original documents from which the causalities are extracted.
